(19) United States
(12) Patent Application Publication
(10) Pub. No.: US 2008/0011687 A1
(43) Pub. Date: Jan. 17, 2008

(54) Silica scale inhibition

(76) Inventors: Floryan De Campo, Burlington, NJ (US); Gary Woodward, Northwich (GB); Bruno Langlois, Paris (FR)

Correspondence Address: MIALEEKA WILLIAMS;RHODIA INC., 8 CEDAR BROOK DRIVE (CN 7500), CRANBURY, NJ, 08512-7500, US

(21) Appl. No.: 11/487,658

(22) Filed: Jul. 17, 2006

(51) Int. Cl. C02F 1/00

(52) U.S. Cl. 210/701; 210/652; 210/747; 210/698

(57) ABSTRACT

A method of inhibiting silica/silicate scale in aqueous systems is disclosed which comprises the addition to an aqueous system of a scale inhibiting amount of an ester of (A) a carboxylic acid functional polymer obtained by polymerizing an ethylenically unsaturated carboxylic monomer or copolymerizing the ethylenically unsaturated carboxylic monomer with one or more additional ethylenically unsaturated monomers and (B) a hydroxyl functional polyether obtained by reacting an alkyl alcohol with an alkylene oxide.

### BACKGROUND OF THE INVENTION

This invention is in the field of controlling silica and silicate fouling in aqueous systems.

Silica and silicate scale is a prevalent problem in water treatment industry and unique due to the complexity of its mechanism. Silica/silicate scale is also very difficult to remove once formed and as a result its formation should be inhibited or retarded as much as possible. Acumer® 5000 and Good-rite® K-XP212 are two industry standards for silica/silicate scale control. Acumer® 5000 is a polymer having strong sulfonate, weak carboxylate, and hydrophilicity-lipophilicity balance (HLB) functionality, and is understood to be described in European Patent 0459661 B1 entitled Silica Scale Inhibition, assigned to Rohm and Haas Company. Good-rite® K-XP212 copolymer is understood to be described in U.S. Pat. No. 4,566,973, originally assigned to B.F. Goodrich Company and presently assigned to Noveon, Inc., as a water-soluble non-crosslinked random copolymer of 50 to 90 weight parts of an acrylic acid and 10 to 50 weight parts of a substituted acrylamide.

While the aforementioned commercial products are adequate for many silica and silicate scale inhibition applications, for many applications and under many conditions they are insufficient and therefore there remains a need for improved silica/silicate scale inhibitors.

### SUMMARY OF THE INVENTION

This need is addressed by the present invention which in one aspect is a method of inhibiting silica and/or silicate scale which comprises the addition to an aqueous system of a scale inhibiting amount of an ester of (A) a carboxylic acid functional polymer obtained by polymerizing an ethylenically unsaturated carboxylic monomer or copolymerizing the ethylenically unsaturated carboxylic monomer with one or more additional ethylenically unsaturated monomers and (B) a hydroxyl functional polyether obtained by reacting an alkyl alcohol with one or more alkylene oxides.

The ester can be added in various concentrations, depending on the amount of scale which must be controlled, the type of aqueous system, the pH and other conditions of the aqueous system, for example. A concentration of about 0.1 to 1000 ppm is usually sufficient.

The ester can be used in a wide variety of aqueous systems, for example cooling towers, boilers, production of sugar, enhanced oil recovery, a geothermal process, detergent applications, reverse osmosis, geothermal, and desalination of water.

The ester can be prepared in the presence of a base such as sodium hydroxide or lithium hydroxide, which acts as a catalyst for the esterification reaction. Depending on the conditions of polymerization and the starting materials, about 10 to 90% by weight of the carboxyl functional groups of (A) can be esterified. Preferably about 30 to 70% of the carboxylic functional groups of (A) are esterified.

The carboxyl functional polymer (A) can have at least one carboxyl group, but preferably has at least six carboxyl functional groups, per molecule.

The carboxyl functional polymer (A) is a homopolymer of an ethylenically unsaturated carboxylic acid monomer, for example poly(acrylic acid) or poly(methacrylic acid), or a copolymer of at least one ethylenically unsaturated carboxylic acid monomer and one or more other ethylenically unsaturated monomers such as methyl acrylate, methyl methacrylate, ethyl acrylate, ethyl methacrylate, propyl acrylate, propyl methacrylate, butyl acrylate, and/or butyl methacrylate. In addition to acrylic acid and methacrylic acid, the carboxylic acid monomer can be a non-acrylic monomer such as maleic acid.

The hydroxyl functional polyether can be obtained by reacting one or more alkylene oxides selected from the group consisting of ethylene oxide, and propylene oxide, butylene oxide

### BRIEF DESCRIPTION OF THE DRAWINGS

FIG. 1 is a graphical representation of the results of testing the invention versus two benchmarks at pH 8.

FIG. 2 is a graphical representation of the results of testing the invention versus two benchmarks at pH 9

FIG. 3 is a graphical representation of the results of testing of various embodiments of the invention, using esters, versus using two benchmarks, Acumer 5000 and GRXP212 at pH 9.

FIG. 4 is a graphical representation of the results of testing of various embodiments of the invention, using esters, versus using two benchmarks, Acumer 5000 and GRXP212 at pH 9.

### DETAILED DESCRIPTION OF THE INVENTION

The phrase “silica/silicate” is intended to include silica, silicate, and mixtures thereof. The method of the invention is applicable to any aqueous system where silica/silicate scale must be inhibited, the most typical of which are cooling towers, boilers, aqueous sugar concentrate evaporated during sugar production, drive fluids used to enhance oil recovery, and a aqueous systems undergoing controlled temperature reduction in geothermal processes.

According to the invention, a scale inhibiting amount of an ester of (A) a carboxylic acid functional polymer obtained by polymerizing an ethylenically unsaturated carboxylic monomer or copolymerizing the ethylenically unsaturated carboxylic monomer with one or more additional ethylenically unsaturated monomers and (B) a hydroxyl functional polyether obtained by reacting an alkyl alcohol with one or more alkylene oxides. Since the carboxylic acid functional polymer will usually have more than one carboxyl group, most or all of the carboxyl groups will react with the terminal hydroxyl groups of the hydroxyl functional polyether molecules.

The esters used in this invention can be prepared by the method described in French patent 2776285 A1, Guicquero, et al., published Sep. 24, 1999, which disclosed these esters as base catalyzed partial esters obtained by reacting a polycarboxylic acid obtained by polymerizing an unsaturated acid and a polyether containing a free hydroxyl group capable of reacting with one carboxylic function of the carboxylic acid, used as dispersants for cement compositions and mineral particle aqueous suspensions. The French patent 2776285 A1 is hereby incorporated by reference for its teachings of preparation of the partial esters.

The following examples are presented to illustrate a few embodiments of the invention. All parts and percentages are by weight unless otherwise indicated.

### EXAMPLE 1

### Scale Inhibition of the Invention Versus Prior Art

A static test was first employed to demonstrate the improved property of silica/silicate scale inhibition of the esters of the present invention compared with a control and other scale inhibitors. The control had no silica scale inhibitor. The comparative silica scale inhibitors were Acumer 5000 and Good-rite K-XP212. A high silica solution was prepared by mixing deionized water, sodium silicate solution (a) and a calcium chloride and magnesium chloride solution (b), which were prepared from Analytical Reagent grade chemicals (unless otherwise stated):

(a) Sodium Silicate Solution

| | |
|---|---|
| Sodium silicate pentahydrate | 35.32 g/L |

The solution as such contained 10,000 ppm as silica (SiO₂)

(b) Calcium/Magnesium Solution

| | |
|---|---|
| Calcium chloride dihydrate | 29.40 g/L |
| Magnesium chloride hexahydrate | 40.66 g/L |

The solution as such contained 8,000 ppm of calcium (Ca) and 4,860 ppm of magnesium (Mg).

The final composition of the test solutions was as follows:

| | |
|---|---|
| Silica (SiO2) | 500 ppm |
| Calcium (Ca) | 120 ppm (500 ppm as CaCO₃) |
| Magnesium (Mg) | 200 ppm (500 ppm as CaCO₃) |
| Inhibitor | 100 ppm |

Sodium silicate solution (a) was added to 183 mL of deionized water (in a stirred plastic beaker. Then 2 mL of inhibitor or 2 mL of water (for the blank) was added. The pH was adjusted to 7 with diluted hydrochloric acid and sodium hydroxide. Then solution (b) was added and the pH was adjusted to 8 or 9. The final test solution was rapidly transferred into a plastic bottle and placed in an oven at 40° C. Samples of solution were taken over time and filtered through a 0.2 μm filter before being analyzed for silica in solution according to the standard Hach method.

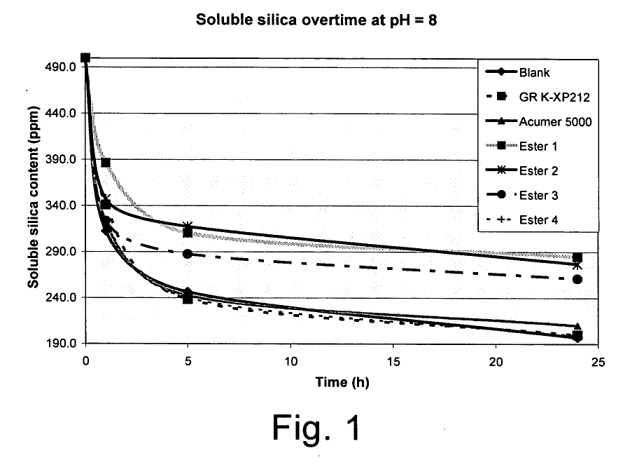

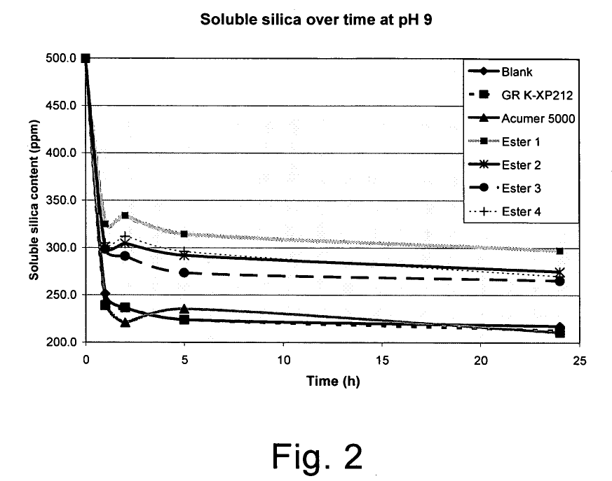

FIGS. 1 and 2 show that in these test conditions the two standards, Acumer 5000 and GR K-XP212 did not allow retention of any more silica in solution that the blank. On the contrary, at pH 8 (FIG. 1) three of the four esters used according to the invention provided substantial scale inhibition by retaining more silica and or silicate than the blank. At pH 9 (FIG. 2), all the esters showed some performance.

Performance, with respect to silica/silicate inhibition, was also determined by use of the formula: % Inhibition=[Si(inhib)−Si(blank)]/[Si(initial)−Si(blank)]×100

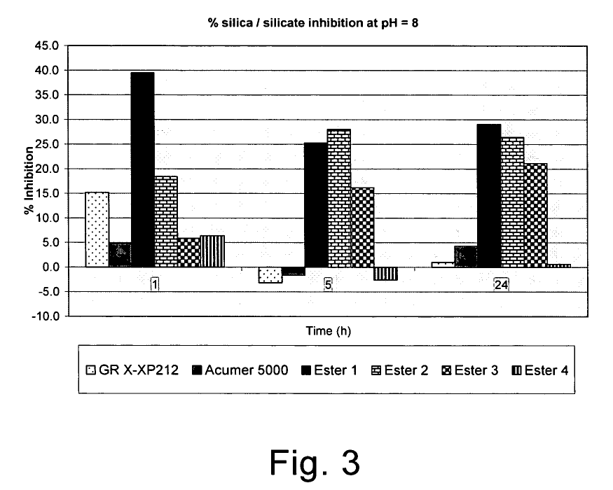

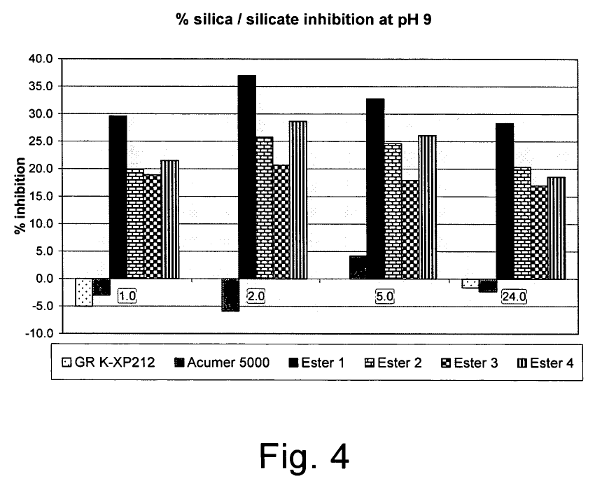

FIGS. 3 and 4 show the results expressed as % silica/silicate inhibition. At both pH 8 and pH 9, the use of the esters according to the invention did provide substantial inhibition of the silica/silicates while the two standards of the prior art barely had an effect.

While the invention has been described and illustrated in detail herein, various alternatives and modifications should become readily apparent to those skilled in this art without departing from the spirit and scope of the invention.

What is claimed is:

1. A method of inhibiting silica/silicate scale in aqueous systems, which method comprises the addition to an aqueous system of a scale inhibiting amount of an ester of (A) a carboxylic acid functional polymer obtained by polymerizing an ethylenically unsaturated carboxylic monomer or copolymerizing the ethylenically unsaturated carboxylic monomer with one or more additional ethylenically unsaturated monomers and (B) a hydroxyl functional polyether obtained by reacting an alkyl alcohol with one or more alkylene oxides.

2. The method of claim 1, wherein the ester is added to said aqueous system at a concentration of from between 0.1 to 1000 ppm.

3. The method of claim 1 wherein the aqueous system is used in a cooling tower.

4. The method of claim 1 in which the aqueous system is used in an application selected from the group consisting of boilers, production of sugar, enhanced oil recovery, a geothermal process, detergent applications, reverse osmosis, geothermal, and desalination of water.

5. The method of claim 1 wherein the ester is obtained by reacting (A) and (B) in the presence of a base.

6. The method of claim 1 wherein (A) is a polymer of one or more ethylenically unsaturated carboxylic acids selected from the group consisting of acrylic acid and methacrylic acid and optionally one or more monomers selected from the group consisting of methyl acrylate, methyl methacrylate, ethyl acrylate, ethyl methacrylate, propyl acrylate, propyl methacrylate, butyl acrylate, and butyl methacrylate.

7. The method of claim 1 wherein (B) is obtained by reacting one or more alkylene oxides selected from the group consisting of ethylene oxide, propylene oxide, and butylene oxide.

8. The method of claim 1 wherein (A) has on average at least 6 carboxylic functional groups per molecule.

9. The method of claim 1 wherein the ester is obtained by reacting (A) and (B) in the presence of a base selected from the group consisting of sodium hydroxide and lithium hydroxide.

10. The method of claim 1 wherein about 10 to 90% of the carboxylic functional groups of (A) are esterified.

11. The method of claim 1 wherein about 30 to 70% of the carboxylic functional groups of (A) are esterified.
